(19) United States
(12) Patent Application Publication
(10) Pub. No.: US 2022/0163827 A1
(43) Pub. Date: May 26, 2022

(54) OPTICAL DEVICE, OPTICAL COMMUNICATION APPARATUS, AND MANUFACTURING METHOD OF THE OPTICAL DEVICE

(71) Applicant: FUJITSU OPTICAL COMPONENTS LIMITED, Kawasaki-shi (JP)

(72) Inventor: Masaki SUGIYAMA, Kawasaki (JP)

(73) Assignee: FUJITSU OPTICAL COMPONENTS LIMITED, Kawasaki-shi (JP)

(21) Appl. No.: 17/496,304

(22) Filed: Oct. 7, 2021

(30) Foreign Application Priority Data
Nov. 25, 2020 (JP) 2020-195308

(51) Int. Cl. G02F 1/035; G02F 1/225; G02F 1/21

(52) U.S. Cl. CPC G02F 1/0356; G02F 1/212; G02F 1/2255

(57) ABSTRACT

An optical device has a silicon (Si) substrate, a ground electrode, a lithium niobate (LN) optical waveguide, and a signal electrode. The ground electrode is an electrode that is at ground potential and that is layered on the Si substrate. The LN optical waveguide is an optical waveguide that is formed by a thin film LN substrate that is layered on the ground electrode. The signal electrode is an electrode that is disposed at a position opposite the ground electrode with the LN optical waveguide interposed therebetween and that applies a high-frequency signal.

### CROSS-REFERENCE TO RELATED APPLICATION

This application is based upon and claims the benefit of priority of the prior Japanese Patent Application No. 2020-195308, filed on Nov. 25, 2020, the entire contents of which are incorporated herein by reference.

### FIELD

The embodiments discussed herein are related to an optical device, an optical communication apparatus, and a manufacturing method of the optical device.

### BACKGROUND

In general, for example, an optical device, such as an optical modulator, includes an optical modulator chip in which an optical waveguide is formed on the surface of the optical modulator chip. A signal electrode is disposed on the optical waveguide that is formed on the optical modulator chip and, if a voltage is applied to the signal electrode, an electric field in a vertical direction with respect to the surface of the optical modulator chip is generated inside the optical waveguide. The refractive index of the optical waveguide varies due to the electric field; therefore, the phase of light propagating in the optical waveguide is changed and it is thus possible to modulate the light. Namely, the optical waveguide formed on the optical modulator chip constitutes, for example, a Mach-Zehnder interferometer and is able to output, for example, IQ signals that are subjected to XY polarization division multiplexing on the basis of phase differences of the light between a plurality of optical waveguides that are disposed in parallel.

If the optical modulator chip performs high-speed modulation, a high-speed signal with a band of, for example, several tens of gigahertz (GHz) is input to a signal electrode that is disposed along the optical waveguide. Consequently, a coplanar waveguide (CPW) structure that is able to obtain a wide band transmission characteristic is sometimes used for the signal electrode. Namely, a signal electrode and a pair of ground electrodes that sandwiches the signal electrode are sometimes disposed above the optical waveguide.

In contrast, the optical waveguide is sometimes formed at a position overlapping a position of the signal electrode by spreading, for example, metals, such as titanium, from the surface of a substrate. Furthermore, a thin film optical waveguide using a thin film of a lithium niobate (LN) crystal is sometimes formed at the position overlapping the position of the signal electrode. A thin film optical waveguide is able to confine light more strongly as compared to when a diffusion optical waveguide that diffuses metal is used, is able to improve an application efficiency of the electric field, and is able to decrease a drive voltage.

FIG. 14 is a schematic plan view illustrating an example of a configuration of an optical modulator 100. The optical modulator 100 illustrated in FIG. 14 has a configuration in which an optical fiber from a light source is connected to an input side of the optical modulator 100 and an optical fiber that is used to output a transmission signal is connected to an output side of the optical modulator 100. The optical modulator 100 has an optical input unit 110, an RF modulating unit 120, and an optical output unit 130. The optical input unit 110 includes a first Si optical waveguide 111 and a first LN-Si waveguide joining unit 112. The first Si optical waveguide 111 has a single Si optical waveguide connected to the optical fiber on the input side, two Si optical waveguides that are branched off from the single Si optical waveguide, four Si optical waveguides that are branched off from the associated two Si optical waveguides, and eight Si optical waveguides that are branched off from the associated four Si optical waveguides. The first LN-Si waveguide joining unit 112 joins a portion between the eight Si optical waveguides included in the first Si optical waveguide 111 and the respective eight LN optical waveguides included in an LN optical waveguide 121 included in the RF modulating unit 120.

The RF modulating unit 120 has the LN optical waveguide 121, a signal electrode 122, and a RF terminator 123. When light supplied from the first Si optical waveguide 111 propagates through the LN optical waveguide 121, the RF modulating unit 120 modulates the light by the electric field applied by the signal electrode 122. The LN optical waveguide 121 is an optical waveguide formed by using, for example, a thin film LN substrate 154 and has eight LN optical waveguides that are disposed in parallel and that are joined to the respective first LN-Si waveguide joining unit 112 in the optical input unit 110. The light modulated by propagating through the LN optical waveguide 121 is output to the optical output unit 130.

The signal electrode 122 is a transmission path with a CPW structure provided at a position overlapping a positon of the LN optical waveguide 121 and applies an electric field to the LN optical waveguide 121 in accordance with the electrical signal with, for example, several tens of gigahertz (GHz) that is output from the DSP. The termination of the signal electrode 122 is connected to the RF terminator 123. The RF terminator 123 is connected to the termination of the signal electrode 122 and prevents unneeded reflection of a signal transmitted by the signal electrode 122.

The optical output unit 130 has a second LN-Si waveguide joining unit 131, a second Si optical waveguide 132, eight child-side Mach-Zehnder (MZ) 133, and four parent-side MZ 134. Furthermore, the optical output unit 130 has a polarization rotator (PR) 135 and a polarization beam combiner (PBC) 136. The second LN-Si waveguide joining unit 131 joins the LN optical waveguide 121 in the RF modulating unit 120 and the second Si optical waveguide 132. The second Si optical waveguide 132 has eight Si optical waveguides connected to the second LN-Si waveguide joining unit 131 and includes four Si optical waveguides that merge with the two Si optical waveguides out of the eight Si optical waveguides. Furthermore, the second Si optical waveguide 132 has the two Si optical waveguides that merge with the two Si optical waveguides out of the four Si optical waveguides and includes a single Si optical waveguide that merge with the two Si optical waveguides and that is connected to the optical fiber on the output side.

The eight Si optical waveguides included in the second Si optical waveguide 132 are provided with the child-side MZ 133 for each Si optical waveguide. By applies a bias voltage to a DC electrode on the Si optical waveguide, the set of the child-side MZ 133 adjusts the bias voltage such that ON/OFF of the electrical signal is associated with the ON/OFF of the optical signal, and then, outputs an I signal or a Q signal. Each of the four Si optical waveguides included in the second Si optical waveguide 132 is provided with the parent-side MZ 134 for each Si optical waveguide. By applying a bias voltage to the DC electrode on the Si optical waveguide, the set of the parent-side MZ 134 adjusts the bias voltage such that ON/OFF of the electrical signal is associated with ON/OFF of the optical signal, and then, outputs a I signal or a Q signal.

The PR 135 rotates the I signal or the Q signal that is input from one of the set of the parent-side MZ 134 by 90 degrees and obtains a vertical polarization optical signal that is rotated by 90 degrees. Then, the PR 135 inputs the vertical polarization optical signal to the PBC 136. The PBC 136 multiplexes the vertical polarization optical signal that is input from the PR 135 and the horizontal polarization optical signal that is input from the other set of the parent-side MZ 134, and then, outputs a polarization division multiplexing signal.

FIG. 15 is a semantic cross-sectional diagram illustrating an example of the optical modulator 100 taken along line F-F. The cross-sectional view of the portion taken along line F-F illustrated in FIG. 14 is a semantic cross-sectional view of the first LN-Si waveguide joining unit 112. The first LN-Si waveguide joining unit 112 illustrated in FIG. 15 has a Si substrate 151, a Box layer 152 of SiO₂ (silicon dioxide) layered on the Si substrate 151, and a first buffer layer 153 of SiO₂ layered on the Box layer 152. Furthermore, the first LN-Si waveguide joining unit 112 has the thin film LN substrate 154 layered on the first buffer layer 153 and a second buffer layer 155 of SiO₂ layered on the thin film LN substrate 154. The first Si optical waveguide 111 is formed at the center of the first buffer layer 153. The LN optical waveguide 121 that protrudes upward is formed at the center of the thin film LN substrate 154. By allowing the first Si optical waveguide 111 and the LN optical waveguide 121 to vertically approach, the first Si optical waveguide 111 and the LN optical waveguide 121 are subjected to directional coupling.

FIG. 16 is a semantic cross-sectional diagram illustrating an example of the optical modulator 100 taken along ling G-G. The cross-sectional view of the portion taken along G-G illustrated in FIG. 14 is a semantic cross-sectional view of the RF modulating unit 120. The RF modulating unit 120 illustrated in FIG. 16 has the Si substrate 151, the Box layer 152 of SiO₂ layered on the Si substrate 151, and a first buffer layer 153 layered on the Box layer 152. Furthermore, the RF modulating unit 120 has the thin film LN substrate 154 layered on the first buffer layer 153 and the second buffer layer 155 of SiO₂ layered on the thin film LN substrate 154. The LN optical waveguide 121 that protrudes upward is formed at the center of the thin film LN substrate 154. The signal electrode 122 with the CPW structure is disposed on the surface of the second buffer layer 155. Namely, the signal electrode 122 is disposed at a position that overlaps a position of the LN optical waveguide 121 and a pair of a ground electrodes 122A that sandwiches the signal electrode 122 is disposed on the second buffer layer 155.

The LN optical waveguide 121 having the configuration described above is able to modulate light propagating through the LN optical waveguide 121 by generating an electric field by applying a high-frequency signal to the signal electrode 122 and by changing the refractive index of the LN optical waveguide 121. Furthermore, the thin film LN substrate 154 and the LN optical waveguide 121 are layered on the first buffer layer 153; therefore, it is possible to strongly confine light in the LN optical waveguide 121 and it is thus possible to decrease the drive voltage that is applied to the signal electrode 122.
Patent Document 1: U.S. Pat. No. 5,189,713
Patent Document 2: International Publication Pamphlet No. WO 2015/087988
Patent Document 3: Japanese Laid-open Patent Publication No. 2003-195239
Patent Document 4: U.S. Pat. No. 7,095,920

If the CPW structure in which the ground electrodes 122A are arranged on both sides of the signal electrode 122 is used as illustrated in FIG. 16, the optical modulator 100 is able to obtain a wide band modulation characteristic by ensuring an interval between the signal electrode 122 and each of the ground electrodes 122A. However, in the optical modulator 100 with the CWP structure, a signal of the signal electrode 122 is greatly affected by a resistance of the Si substrate 151; therefore, a loss of the high-frequency signal is increased and a modulation bandwidth is accordingly degraded.

### SUMMARY

According to an aspect of an embodiment, an optical device includes a silicon (Si) substrate; a ground electrode that is at a ground potential and that is layered on the Si substrate; a lithium niobate (LN) optical waveguide that is formed by a thin film lithium niobate (LN) substrate that is layered on the ground electrode; and a signal electrode that is disposed at a position opposite the ground electrode with the LN optical waveguide interposed therebetween and that applies a high-frequency signal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of an optical communication apparatus according to a present embodiment;

FIG. 2 is a schematic plan diagram illustrating an example of a configuration of an optical modulator according to a first embodiment;

FIG. 3 is a semantic cross-sectional view illustrating an example of the optical modulator according to the first embodiment taken along line A-A;

FIG. 4 is a diagram illustrating an example of an EO response characteristic of an optical modulator with a CPW structure and an optical modulator with a MSL structure;

FIG. 5A is a diagram illustrating an example of a manufacturing process of a first optical input unit and a RF modulating unit of the optical modulator;

FIG. 5B is a diagram illustrating an example of a manufacturing process of the first optical input unit and the RF modulating unit of the optical modulator;

FIG. 5C is a diagram illustrating an example of a manufacturing process of the first optical input unit and the RF modulating unit of the optical modulator;

FIG. 6 is a semantic cross-sectional diagram illustrating an example of the optical modulator illustrated in FIG. 5 taken along line B-B;

FIG. 7 is a semantic cross-sectional view illustrating an example of the optical modulator illustrated in FIG. 5 taken along line C-C;

FIG. 8 is a schematic plan view illustrating an example of a configuration of an optical modulator according to a second embodiment;

FIG. 9 is a semantic cross-sectional diagram illustrating an example of the optical modulator according to the second embodiment taken along line D-D;

FIG. 10 is a semantic cross-sectional diagram illustrating an example of the optical modulator according to the second embodiment taken along line E-E;

FIG. 11 is a diagram illustrating an example of a coupling structure of a first Si optical waveguide, a first SiN optical waveguide, and an LN optical waveguide;

FIG. 12 a diagram illustrating another example of the coupling structure of the first Si optical waveguide, the first SiN optical waveguide, and the LN optical waveguide;

FIG. 13 is a schematic plan view illustrating an example of a configuration of an optical modulator according to a third embodiment;

FIG. 14 is a schematic plan view illustrating an example of a configuration of an optical modulator;

FIG. 15 is a semantic cross-sectional diagram illustrating an example of the optical modulator taken along line F-F; and

FIG. 16 is a semantic cross-sectional diagram illustrating an example of the optical modulator taken along line G-G.

### DESCRIPTION OF EMBODIMENTS

Preferred embodiments of the present invention will be explained with reference to accompanying drawings. Furthermore, the present invention is not limited to the embodiments.

### [a] First Embodiment

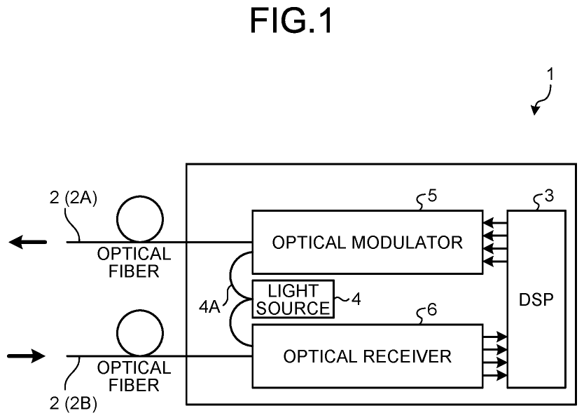

FIG. 1 is a block diagram illustrating an example of a configuration of an optical communication apparatus 1 according to an embodiment. The optical communication apparatus 1 illustrated in FIG. 1 is connected to an optical fiber 2A (2) disposed on the output side and the optical fiber 2B (2) disposed on the input side. The optical communication apparatus 1 has a digital signal processor (DSP) 3, a light source 4, an optical modulator 5, and an optical receiver 6. The DSP 3 is an electrical component that performs digital signal processing. The DSP 3 performs a process of, for example, encoding transmission data or the like, generates an electrical signal including the transmission data, and outputs the generated electrical signal to the optical modulator 5. Furthermore, the DSP 3 acquires an electrical signal including reception data from the optical receiver 6 and obtains reception data by performing a process of decoding the acquired electrical signal.

The light source 4 includes, for example, a laser diode or the like, generates light with a predetermined wavelength, and supplies the generated light to the optical modulator 5 and the optical receiver 6. The optical modulator 5 is an optical device that modulates, by using an electrical signal that is output from the DSP 3, the light supplied from the light source 4 and that outputs the obtained optical transmission signal to the optical fiber 2A. The optical modulator 5 includes, for example, an LN optical waveguide 31 and a signal electrode 32 that has a micro strip line (MSL) structure. The optical modulator 5 generates an optical transmission signal by modulating, when light supplied from the light source 4 propagates through the LN optical waveguide 31, the light by the electrical signal that is input to the signal electrode 32.

The optical receiver 6 receives an optical signal from the optical fiber 2B and demodulates the received optical signal by using the light supplied from the light source 4. Then, the optical receiver 6 converts the demodulated received optical signal to an electrical signal, and then, outputs the converted electrical signal to the DSP 3.

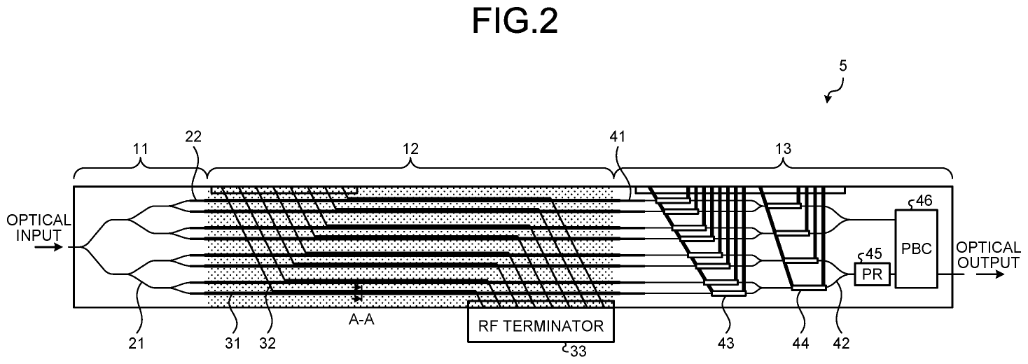

FIG. 2 is a schematic plan view illustrating an example of a configuration of the optical modulator 5 according to the first embodiment. The optical modulator 5 illustrated in FIG. 2 has a configuration in which an optical fiber 4A from the light source 4 is connected to the input side and the optical fiber 2A that is used to output a transmission signal is connected to the output side. The optical modulator 5 has a first optical input unit 11, a RF modulating unit 12, and a first optical output unit 13. The first optical input unit 11 has a first Si optical waveguide 21 and a first LN-Si waveguide joining unit 22. The first Si optical waveguide 21 has a single Si optical waveguide connected to the optical fiber 4A, two Si optical waveguides that are branched off from the single Si optical waveguide, four Si optical waveguides that are branched off from the associated two Si optical waveguides, and eight Si optical waveguides that are branched off from the associated four Si optical waveguides. The first LN-Si waveguide joining unit 22 joins a portion between the eight Si optical waveguides included in the first Si optical waveguide 21 and the respective eight LN optical waveguides included in the LN optical waveguide 31.

The RF modulating unit 12 has the LN optical waveguide 31, the signal electrode 32, and a RF terminator 33. When the light supplied from the first Si optical waveguide 21 propagates through the LN optical waveguide 31, the RF modulating unit 12 modulates the light by using an electric field applied by the signal electrode 32. The LN optical waveguide 31 is an optical waveguide formed by using, for example, a thin film LN substrate 55 and has eight parallel LN optical waveguides obtained by repeatedly branching off from the input side. The light that is modulated while propagating through the LN optical waveguide 31 is output to the first optical output unit 13.

The signal electrode 32 is a transmission path that has the MSL structure and that is disposed at a position overlapping a position of the LN optical waveguide 31 and applies an electric field to the LN optical waveguide 31 in accordance with the electrical signal that is output from the DSP 3. The termination of the signal electrode 32 is connected to the RF terminator 33. The RF terminator 33 is connected to the termination of the signal electrode 32 and prevents unneeded reflection of a signal transmitted by the signal electrode 32.

The optical modulator 5 has a ground electrode 53 between a Si substrate 51 and the signal electrode 32 and a z-cut substrate is assumed to be used for the thin film LN substrate 55 because the direction of the electric field is the vertical direction with respect to the Si substrate 51.

The first optical output unit 13 includes a second LN-Si waveguide joining unit 41, a second Si optical waveguide 42, eight child-side MZs 43, four parent-side MZs 44, a PR 45, and a PBC 46. The second LN-Si waveguide joining unit 41 joins a portion between the LN optical waveguide 31 included in the RF modulating unit 12 and the second Si optical waveguide 42. The second Si optical waveguide 42 has eight Si optical waveguides connected to the second LN-SI waveguide joining unit 41 and also includes four Si optical waveguides that merge with the two associated Si optical waveguides out of the eight Si optical waveguides. Furthermore, the second Si optical waveguide 42 has two Si optical waveguides that merge with the two associated Si optical waveguides out of the four Si optical waveguides and also includes a single Si optical waveguide that merges with the two Si optical waveguides. Each of the eight Si optical waveguides included in the second Si optical waveguide 42 is provided with a child-side Mach-Zehnder (MZ) 43 for each Si optical waveguide. By applying a bias voltage to a DC electrode on the Si optical waveguide, a set of the child-side MZs 43 adjusts the bias voltage such that ON/OFF of the electrical signal is associated with ON/OFF of the optical signal and outputs an I signal having an in-phase component or a Q signal having a quadrature component. Each of the four Si optical waveguides included in the second Si optical waveguide 42 is provided with the parent-side MZ 44 for each Si optical waveguide. By applying a bias voltage to the DC electrode on the Si optical waveguide, a set of the parent-side MZs 44 adjusts the bias voltage such that ON/OFF of the electrical signal is associated with ON/OFF of the optical signal, and then, outputs the I signal or the Q signal.

The PR 45 rotates the I signal or the Q signal that is input from one of the sets of the parent-side MZs 44 by 90 degrees and obtains a vertical polarization optical signal that has been rotated by 90 degrees. Then, the PR 45 inputs the vertical polarization optical signal to the PBC 46. The PBC 46 multiplexes the vertical polarization optical signal that is input from the PR 45 and the horizontal polarization optical signal that is input from the other set of the parent-side MZs 44, and then, outputs a polarization division multiplexing signal.

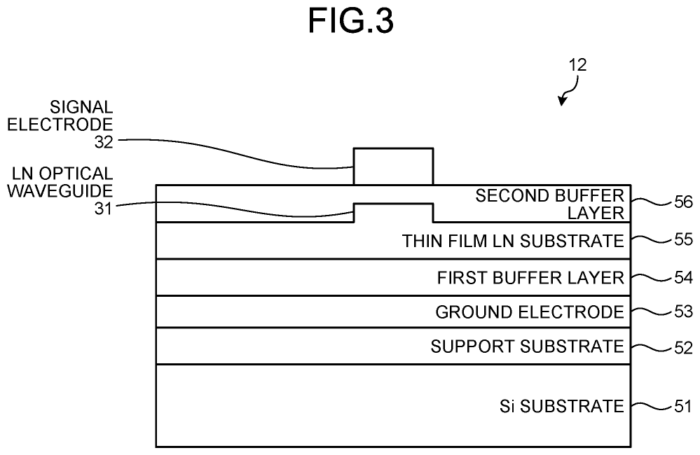

In the following, a configuration of the optical modulator 5 according to the first embodiment will be specifically described. FIG. 3 is a semantic cross-sectional diagram illustrating an example of the optical modulator 5 according to the first embodiment taken along line A-A. The cross-sectional view of the portion taken along line A-A illustrated in FIG. 3 corresponds to the portion of the RF modulating unit 12. The RF modulating unit 12 has the Si substrate 51, a support substrate 52 of SiO₂ layered on the Si substrate 51, the ground electrode 53 with the MSL structure layered on the support substrate 52, and a first buffer layer 54 layered on the ground electrode 53. Furthermore, the RF modulating unit 12 has the thin film LN substrate 55 layered on the first buffer layer 54, a second buffer layer 56 layered on the thin film LN substrate 55, and the signal electrode 32 with the MSL structure layered on the second buffer layer 56.

The Si substrate 51 is a Si substrate with a thickness of, for example, several hundreds of micrometers (μm). The support substrate 52 is a substrate made of, for example, SiO₂ (silicon dioxide) or TiO₂ (titanium dioxide). The ground electrode 53 is an electrode that is at a ground potential and that has a thickness of, for example, 1 μm or more made of metal, such as copper. The ground electrode 53 is able to reduce a loss of a high frequency by decreasing the effect of the electric field signal from the signal electrode 32 to the Si substrate 51. The first buffer layer 54 is a layer formed of, for example, a transparent member having a high refractive index, such as SiO₂ or TiO₂, with a thickness of 1 to 10 μm. Similarly, the second buffer layer 56 is a layer formed of, for example, SiO₂ or TiO₂ with a thickness of 0.2 to 3 μm.

The thin film LN substrate 55 with a thickness of 0.5 to 3 μm is sandwiched between the first buffer layer 54 and the second buffer layer 56, and the LN optical waveguide 31 that protrudes upward is formed at the center of the thin film LN substrate 55. The width of the protrusion corresponding to the LN optical waveguide 31 is about, for example, 1 to 8 μm. The thin film LN substrate 55 and the LN optical waveguide 31 are covered by the second buffer layer 56 and the signal electrode 32 is disposed on the surface of the second buffer layer 56. Namely, the signal electrode 32 is disposed opposite the ground electrode 53 with the LN optical waveguide 31 therebetween and constitutes a transmission path with the MSL structure.

It is preferable that the film of the ground electrode 53 with the MSL structure be formed by using a Si wafer manufacturing process technology as compared with the ground electrode with the CPW structure. Furthermore, it is preferable that a material be selected in view of adhesion between the ground electrode 53 and the first buffer layer 54. Furthermore, it is preferable that the signal electrode 32 be a material that is different from that of the ground electrode 53 and that has a small high frequency loss.

The signal electrode 32 is formed of, for example, a metal material, such as gold or copper, and is an electrode with a width of 2 to 10 μm and a thickness of 1 to 20 μm. The ground electrode 53 is formed of, for example, a metal material, such as aluminum, and is an electrode with a thickness of 1 μm or more. A high-frequency signal in accordance with the electrical signal that is output from the DSP 3 is transmitted by the signal electrode 32, so that an electric field in a direction from the signal electrode 32 toward the ground electrode 53 is generated and the electric field is applied to the LN optical waveguide 31. Consequently, the refractive index of the LN optical waveguide 31 is changed in accordance with the electric field applied to the LN optical waveguide 31 and it is thus possible to modulate the light that propagates through the LN optical waveguide 31.

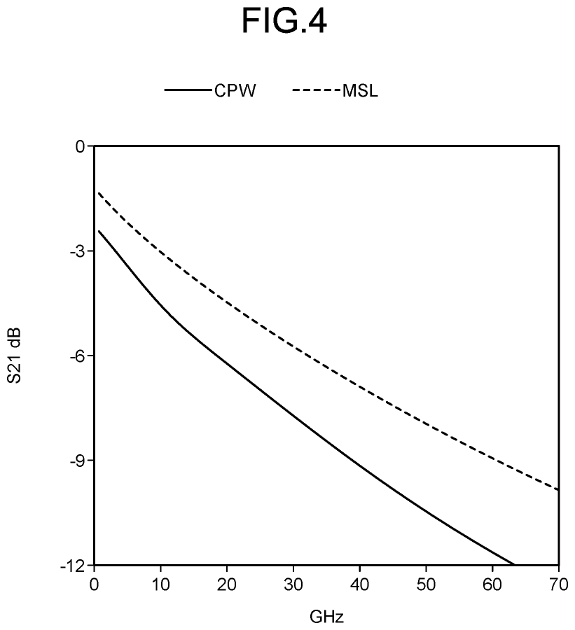

FIG. 4 is a diagram illustrating an example of EO response characteristics of the optical modulator 100 with the CPW structure and the optical modulator 5 with the MSL structure. The optical modulator 5 with the MSL structure according to the first embodiment is able to improve the EO response characteristic as illustrated in FIG. 4, as compared to the conventional optical modulator 100 with the CPW structure. In particular, the EO response characteristic is remarkably improved in a high-frequency band.

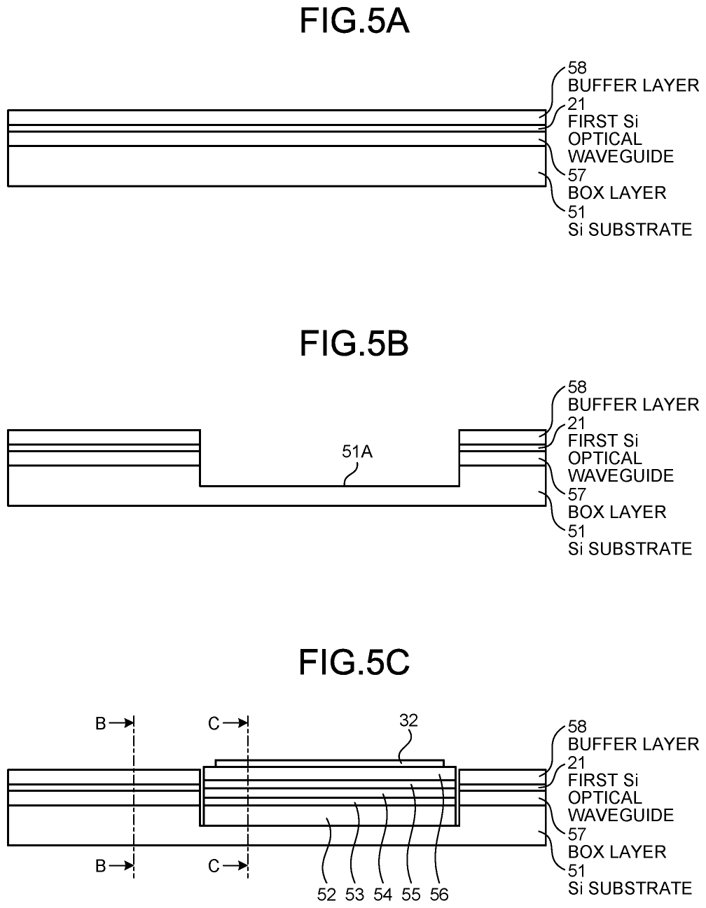

FIG. 5A to FIG. 5C are diagrams each illustrating an example of a manufacturing process of each of the first optical input unit 11 and the RF modulating unit 12 included in the optical modulator 5. In FIG. 5A, the first optical input unit 11 is formed of a first member having the Si substrate 51, a Box layer 57 layered on the Si substrate 51, the first Si optical waveguide 21 layered on the Box layer 57, a buffer layer 58 layered on the first Si optical waveguide 21. In FIG. 5B, the RF modulating unit 12 forms a square recess portion 51A with a deep groove structure in the first member by performing etching on a portion between the buffer layer 58 and a part of the Si substrate 51 on the surface of the first member. In FIG. 5C, in the recess portion 51A on the Si substrate 51, an LN chip is embedded using the flip chip mounting such that the optical axis of the first Si optical waveguide 21 is aligned with the optical axis of the LN optical waveguide 31 on the thin film LN substrate 55. The LN chip has the support substrate 52, the ground electrode 53 layered on the support substrate 52, the first buffer layer 54 layered on the ground electrode 53, and the thin film LN substrate 55 layered on the first buffer layer 54. Furthermore, the LN chip has the second buffer layer 56 layered on the thin film LN substrate 55 and the signal electrode 32 with the MSL structure layered on the second buffer layer 56. The LN chip is a second member.

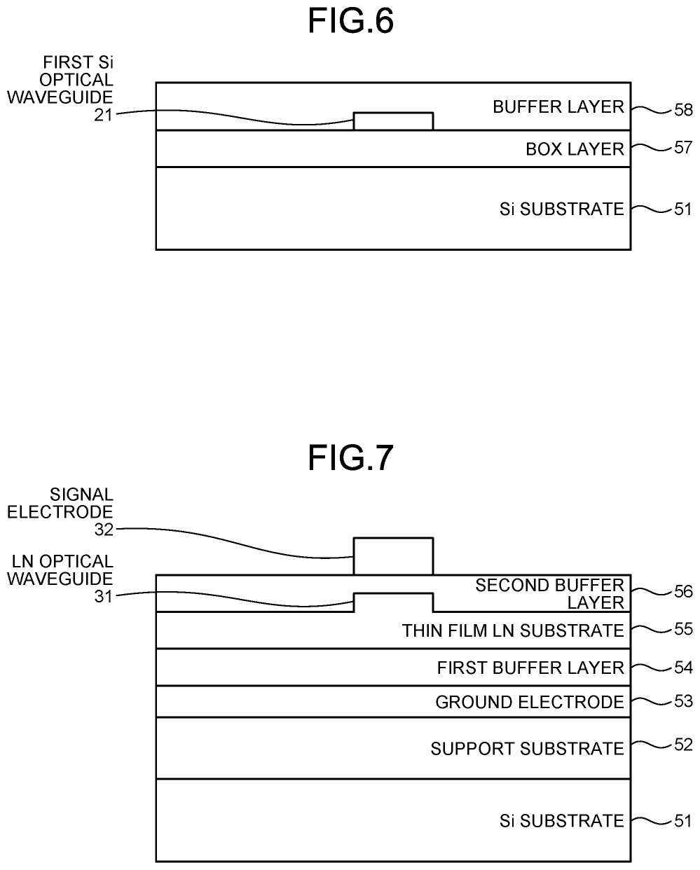

FIG. 6 is a semantic cross-sectional diagram illustrating an example of the optical modulator 5 illustrated in FIG. 5 taken along line B-B. The cross-sectional view of the portion taken along line B-B illustrated in FIG. 6 corresponds to, for example, a portion of the first optical input unit 11, and has the Si substrate 51, the Box layer 57 layered on the Si substrate 51, the first Si optical waveguide 21 formed on the Box layer 57, and the buffer layer 58 layered on the Box layer 57.

FIG. 7 is a semantic cross-sectional diagram illustrating an example of the optical modulator 5 illustrated in FIG. 5 taken along line C-C. The cross-sectional view of the portion taken along line C-C illustrated in FIG. 7 corresponds to, for example, a portion of the RF modulating unit 12. The RF modulating unit 12 has the Si substrate 51, the support substrate 52 layered on the Si substrate 51, the ground electrode 53 layered on the support substrate 52, and the first buffer layer 54 layered on the ground electrode 53. Furthermore, the RF modulating unit 12 has the thin film LN substrate 55 that has the LN optical waveguide 31 and that is layered on the first buffer layer 54, the second buffer layer 56 layered on the thin film LN substrate 55, and the signal electrode 32 with the MSL structure on the second buffer layer 56. The RF modulating unit 12 is formed by embedding the second member of the LN chip in the recess portion 51A that is formed in the first member.

The optical modulator 5 according to the first embodiment has the Si substrate 51, the ground electrode 53 at ground potential layered on the Si substrate 51, and the LN optical waveguide 31 that is formed by the thin film LN substrate 55 that is layered on the ground electrode 53. Furthermore, the optical modulator 5 is disposed at a position opposite the ground electrode 53 with the LN optical waveguide 31 interposed therebetween and has the signal electrode 32 that applies a high-frequency signal. The ground electrode 53 is included between the Si substrate 51 and the signal electrode 32; therefore, the Si substrate 51 is not affected by a signal from the signal electrode 32 due to the ground electrode 53. Consequently, the optical modulator 5 is able to improve the EO response characteristic in a high-frequency bandwidth by preventing the modulation bandwidth from being degraded due to the effect of the resistance of the Si substrate 51.

The optical modulator 5 has the first buffer layer 54 that is layered between the ground electrode 53 and the thin film LN substrate 55 and has the second buffer layer 56 that is layered on the thin film LN substrate 55 and that covers the LN optical waveguide 31. The signal electrode 32 is disposed at a position overlapping the position of the LN optical waveguide 31 on the surface of the second buffer layer 56. Because an electric field in the vertical direction is generated in the LN optical waveguide 31 and because the LN optical waveguide 31 confines light more strongly as compared to when a diffusion optical waveguide that diffuses metal is used, the signal electrode 32 is able to improve the application efficiency of the electric field and decrease a drive voltage.

Furthermore, for convenience of description, in the optical modulator 5 according to the first embodiment, a case in which directional coupling is structured between the first Si optical waveguide 21 and the LN optical waveguide 31 has been exemplified; however, a portion between the first Si optical waveguide 21 and the LN optical waveguide may also be coupled using butt coupling, and appropriate modifications are possible.

There is a need to increase a thickness of the first buffer layer 54 to dispose the first buffer layer 54 between the thin film LN substrate 55 and the ground electrode 53 and layer the ground electrode 53. Therefore, a distance between the LN optical waveguide 31 and the first Si optical waveguide 21 is increased in accordance with an increase in thickness of the first buffer layer 54, so that a coupling length between the LN optical waveguide 31 and the first Si optical waveguide 21 is increased. Thus, in order to cope with this state, optical coupling may also be used between the LN optical waveguide 31 and the first Si optical waveguide 21 using a first SiN optical waveguide 24.

Accordingly, the first Si optical waveguide 21 and the LN optical waveguide 31 may also be coupled by using a first silicon nitride (SiN)—Si waveguide joining unit 23, the first SiN optical waveguide 24, and a first LN-SiN waveguide joining unit 25. This embodiment will be described as a second embodiment.

### [b] Second Embodiment

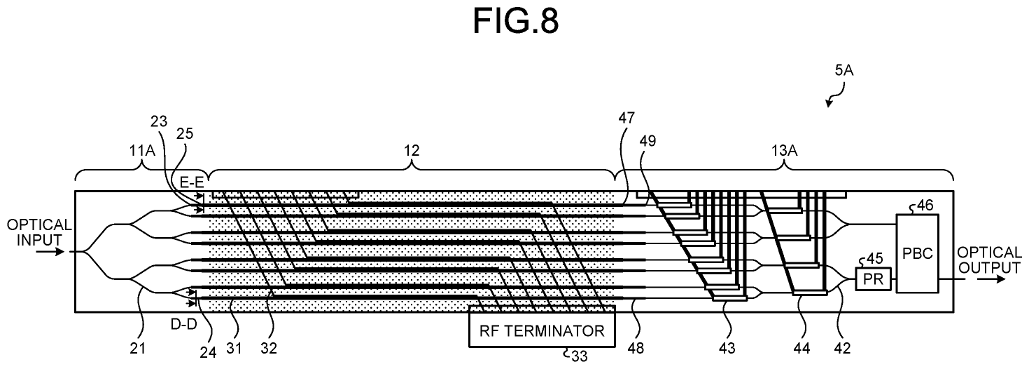

FIG. 8 is a schematic plan view illustrating an example of a structure of an optical modulator 5A according to the second embodiment. Furthermore, by assigning the same reference numerals to components having the same configuration as those in the optical modulator 5 according to the first embodiment, overlapped descriptions of the configuration and the operation thereof will be omitted.

A second optical input unit 11A included in the optical modulator 5A illustrated in FIG. 8 has, instead of the first LN-Si waveguide joining unit 22, the first SiN—Si waveguide joining unit 23, the first SiN optical waveguide 24, and the first LN-SiN waveguide joining unit 25. The first SiN—Si waveguide joining unit 23 joins between eight Si optical waveguides included in the first Si optical waveguide 21 and respective eight SiN optical waveguides included in the first SiN optical waveguide 24. The eight Si optical waveguides included in the first Si optical waveguide 21 are coupled to the eight SiN optical waveguides included in the first SiN optical waveguide 24 by using directional coupling. The first LN-SiN waveguide joining unit 25 couples between the eight SiN optical waveguides included in the first SiN optical waveguide 24 and the respective eight LN optical waveguides included in the LN optical waveguide 31. The eight SiN optical waveguides included in the first SiN optical waveguide 24 are coupled to the respective eight LN optical waveguides included in the LN optical waveguide 31 by using directional coupling.

A second optical output unit 13A included in the optical modulator 5A has, instead of the second LN-Si waveguide joining unit 41, a second LN-SiN waveguide joining unit 47, a second SiN optical waveguide 48, and a second SiN—Si waveguide joining unit 49. The second LN-SiN waveguide joining unit 47 joins between the eight LN optical waveguides included in the LN optical waveguide 31 and the respective eight SiN optical waveguides included in the second SiN optical waveguide 48. The second SiN—Si waveguide joining unit 49 joins between the eight SiN optical waveguides included in the second SiN optical waveguide 48 and the respective eight Si optical waveguides included in the second Si optical waveguide 42.

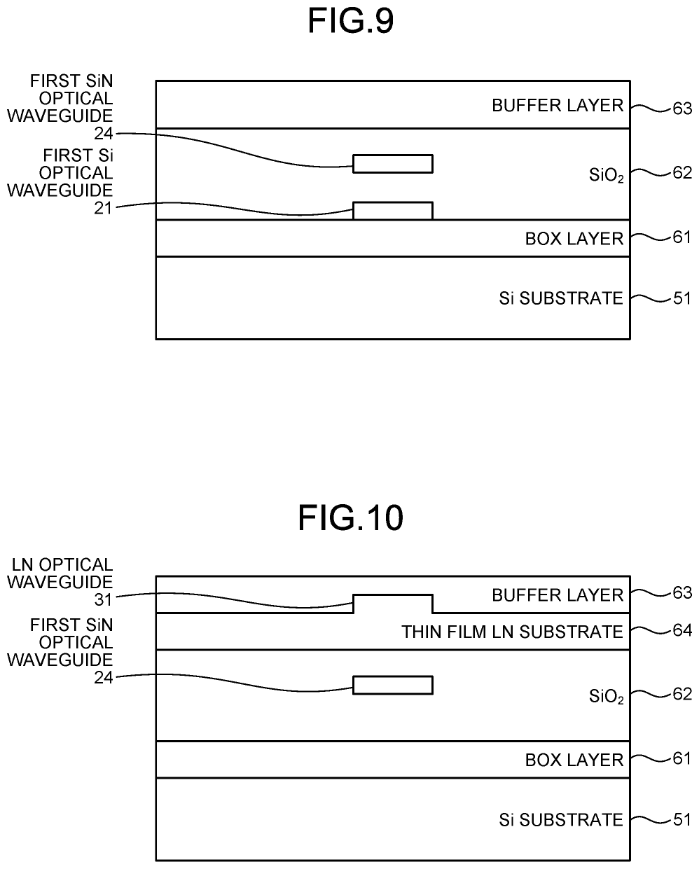

In the following, a configuration of the optical modulator 5A according to the second embodiment will be specifically described. FIG. 9 is a semantic cross-sectional diagram illustrating an example of the optical modulator 5A according to the second embodiment taken along line D-D. The cross-sectional view of the portion taken along line D-D illustrated in FIG. 9 corresponds to a portion of the first SiN—Si waveguide joining unit 23. The first SiN—Si waveguide joining unit 23 has the Si substrate 51, a Box layer 61 of SiO₂ layered on the Si substrate 51, SiO₂ 62 layered on the Box layer 61, and a buffer layer 63 layered on the SiO₂ 62. The SiO₂ 62 includes the first Si optical waveguide 21 and the first SiN optical waveguide 24.

FIG. 10 is a semantic cross-sectional diagram illustrating an example of the optical modulator 5A according to the second embodiment taken along line E-E. The cross-sectional view of the portion taken along line E-E illustrated in FIG. 10 corresponds to a portion of the first LN-SiN waveguide joining unit 25. The first LN-SiN waveguide joining unit 25 has the Si substrate 51, the Box layer 61 of SiO₂ layered on the Si substrate 51, and the SiO₂ 62 layered on the Box layer 61. Furthermore, the first LN-SiN waveguide joining unit 25 has a thin film LN substrate 64 layered on the SiO₂ 62 and the buffer layer 63 layered on the thin film LN substrate 64. The SiO₂ 62 has the first SiN optical waveguide 24. The LN optical waveguide 31 that protrudes upward is formed at the center of the thin film LN substrate 64. A width of the protrusion corresponding to the LN optical waveguide 31 is about, for example, 1 to 8 μm.

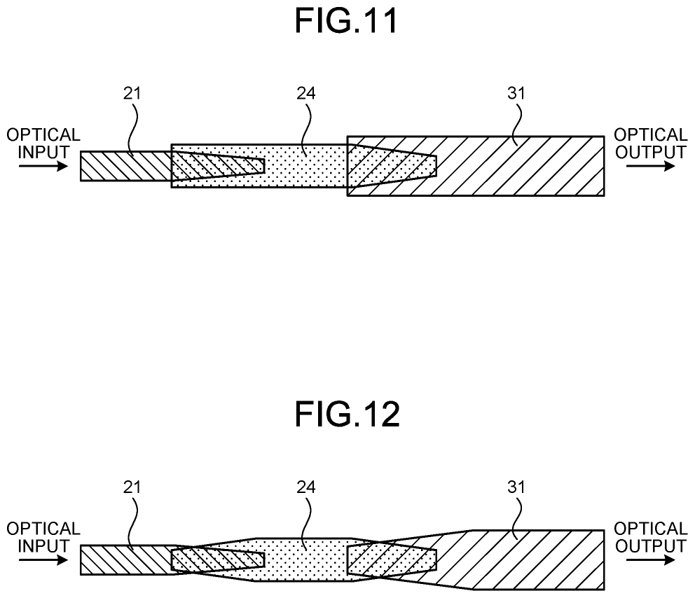

FIG. 11 is a diagram illustrating an example of a coupling structure of the first Si optical waveguide 21, the first SiN optical waveguide 24, and the LN optical waveguide 31. The first Si optical waveguide 21 illustrated in FIG. 11 is joined to the first SiN optical waveguide 24 by tapering the portion connected to the first SiN optical waveguide 24 such that the tip portion of the first Si optical waveguide 21 inserted into the first SiN optical waveguide 24 is tapered. Furthermore, the first SiN optical waveguide 24 is joined to the LN optical waveguide 31 by tapering the portion connected to the LN optical waveguide 31 such that the tip portion of the first SiN optical waveguide 24 inserted into the LN optical waveguide 31 is tapered. Consequently, it is possible to efficiently implement propagation coupling of light from the first Si optical waveguide 21 to the first SiN optical waveguide 24 and propagation coupling of light from the first SiN optical waveguide 24 to the LN optical waveguide 31.

In the optical modulator 5A according to the second embodiment, because the first SiN optical waveguide 24 is used to couple between the first Si optical waveguide 21 and the LN optical waveguide 31 and because the first SiN optical waveguide 24 confines light more weakly as compared to when the first Si optical waveguide 21 is used, it is possible to reduce a length of directional coupling due to an increase in optical mode field. Consequently, it is possible to implement a modulator with a small size and a low drive voltage.

Furthermore, a coupling structure of the first Si optical waveguide 21, the first SiN optical waveguide 24, and the LN optical waveguide 31 may also be configured to have a structure illustrated in FIG. 12. FIG. 12 is a diagram illustrating an example of another coupling configuration of the first Si optical waveguide 21, the first SiN optical waveguide 24, and the LN optical waveguide 31. The portion of the first Si optical waveguide 21 to be connected to the first SiN optical waveguide 24 is tapered such that the tip portion of the first Si optical waveguide 21 inserted into the first SiN optical waveguide 24 is tapered. The portion of the first SiN optical waveguide 24 to be connected to the first Si optical waveguide 21 is gradually made thick in an inverse tapered manner so as to be inversely tapered from the input stage in which the first Si optical waveguide 21 is inserted, and furthermore, a portion of the first SiN optical waveguide 24 to be connected to the LN optical waveguide 31 is tapered such that the tip of the first SiN optical waveguide 24 inserted into the LN optical waveguide 31 is tapered. Furthermore, the portion of the LN optical waveguide 31 to be connected to the first SiN optical waveguide 24 is gradually made thick so as to be inversely tapered such that the tip portion in which the first Si optical waveguide 21 is inserted is inversely tapered. The output stage of the first Si optical waveguide 21 is coupled to the input stage of the first SiN optical waveguide 24, and the output stage of the first SiN optical waveguide 24 is coupled to the input stage of the LN optical waveguide 31. Consequently, it is possible to efficiently implement propagation coupling of light from the first Si optical waveguide 21 to the first SiN optical waveguide 24 and propagation coupling of light from the first SiN optical waveguide 24 to the LN optical waveguide 31.

Furthermore, in the optical modulator 5 according to the first embodiment, a case in which the first Si optical waveguide 21 and the LN optical waveguide 31 are coupled by the first LN-Si waveguide joining unit 22 has been exemplified; however, a first SiN optical waveguide 26 may also be used instead of the first Si optical waveguide 21. This embodiment will be described as a third embodiment.

### [c] Third Embodiment

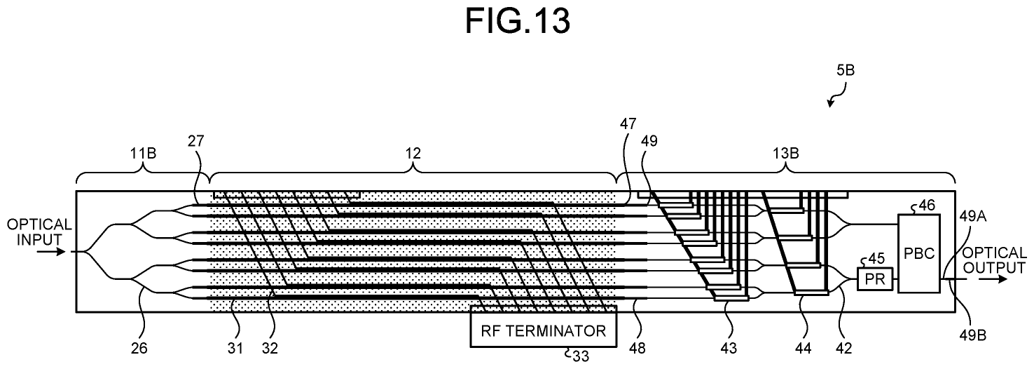

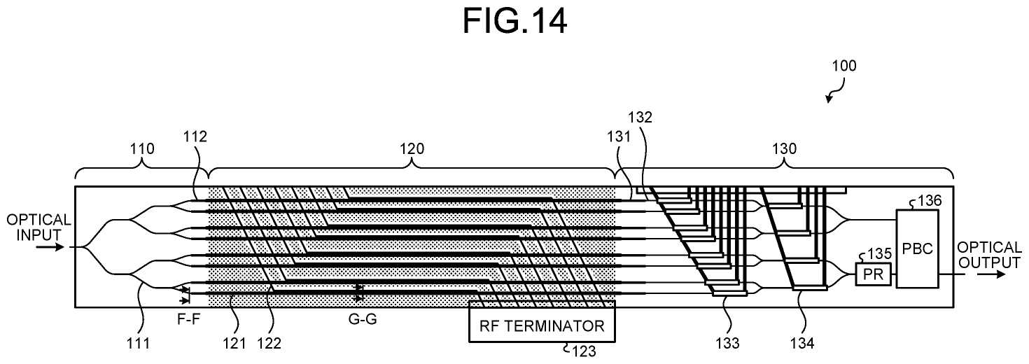

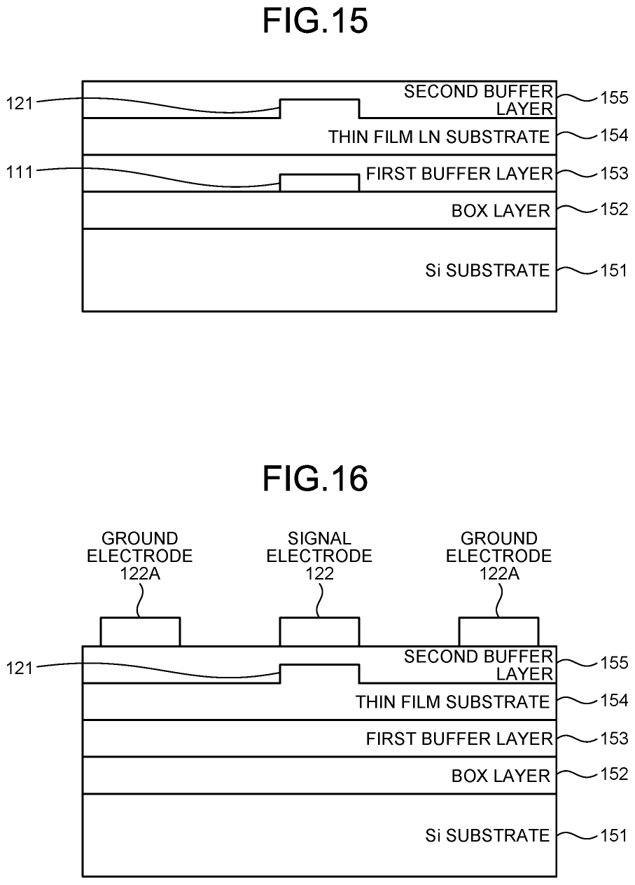

FIG. 13 is a schematic plan view illustrating an example of a configuration of an optical modulator 5B according to the third embodiment. Furthermore, by assigning the same reference numerals to components having the same configuration as those in the optical modulator 5 according to the first embodiment, overlapped descriptions of the configuration and the operation thereof will be omitted.

A third optical input unit 11B illustrated in FIG. 13 uses the first SiN optical waveguide 26 instead of the first Si optical waveguide 21 and uses a first LN-SiN waveguide joining unit 27 instead of the first LN-Si waveguide joining unit 22. The first SiN optical waveguide 26 has a single SiN optical waveguide connected to the optical fiber 2A and includes two two SiN optical waveguides branching off from the single SiN optical waveguide. Furthermore, the first SiN optical waveguide 26 has four SiN optical waveguides branching off from the associated two optical waveguides and eight SiN optical waveguides branching off from the associated four SiN optical waveguides. The first LN-SiN waveguide joining unit 27 joins between the eight SiN optical waveguides included in the first SiN optical waveguide 26 and the respective eight LN optical waveguides included in the LN optical waveguide 31.

A third optical output unit 13B has, instead of the second LN-Si waveguide joining unit 41, the second LN-SiN waveguide joining unit 47, the second SiN optical waveguide 48, the second SiN—Si waveguide joining unit 49, and the second Si optical waveguide 42. Furthermore, the third optical output unit 13B has a third SiN—Si waveguide joining unit 49A and a third SiN optical waveguide 49B.

The second LN-SiN waveguide joining unit 47 joins between the eight LN optical waveguides included in the LN optical waveguide 31 and the respective eight SiN optical waveguides included in the second SiN optical waveguide 48. The second SiN—Si waveguide joining unit 49 joins between the eight SiN optical waveguides included in the second SiN optical waveguide 48 and the respective eight Si optical waveguides included in the second Si optical waveguide 42. The third SiN—Si waveguide joining unit 49A joins between a single Si optical waveguide on the output end side of the second Si optical waveguide 42 and a single SiN optical waveguide included in the third SiN optical waveguide 49B.

The second Si optical waveguide 42 has the eight Si optical waveguides connected to the second SiN—Si waveguide joining unit 49 and four Si optical waveguides that merge with the two Si optical waveguides out of the eight Si optical waveguides. Furthermore, the second Si optical waveguide 42 has the two Si optical waveguides that merge with the two Si optical waveguides out of the four Si optical waveguides and a single Si optical waveguide that merges with the two Si optical waveguides. The eight Si optical waveguides included in the second Si optical waveguide 42 disposes the child-side MZ 43 for each Si optical waveguide. The four Si optical waveguides included in the second Si optical waveguide 42 disposes the parent-side MZ 44 for each Si optical waveguide.

The optical modulator 5B according to the third embodiment is connected to the optical fiber 4A by using the first SiN optical waveguide 26 and is connected to the optical fiber 2A by using the third SiN optical waveguide 49B; therefore, a coupling efficiency between the optical waveguide and the optical fiber is increased.

According to an aspect of an embodiment of the optical device disclosed in the present invention, it is possible to prevent a modulation bandwidth from being degraded.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical device comprising:
a silicon (Si) substrate;
a ground electrode that is at a ground potential and that is layered on the Si substrate;
a lithium niobate (LN) optical waveguide that is formed by a thin film lithium niobate (LN) substrate that is layered on the ground electrode; and
a signal electrode that is disposed at a position opposite the ground electrode with the LN optical waveguide interposed therebetween and that applies a high-frequency signal.

2. The optical device according to claim 1, further comprising:
a first buffer layer that is layered between the ground electrode and the thin film LN substrate; and
a second buffer layer that is layered on the thin film LN substrate and that covers the LN optical waveguide, wherein
the signal electrode is disposed at a position overlapping a position of the LN optical waveguide on a surface of the second buffer layer.

3. The optical device according to claim 1, wherein the ground electrode is formed of a material that is different from that of the signal electrode.

4. The optical device according to claim 1, further comprising:
a support substrate that is formed on the Si substrate; and
a Si optical waveguide that is formed on the support substrate, wherein
the Si optical waveguide and the LN optical waveguide are coupled.

5. The optical device according to claim 4, further comprising a silicon nitride (SiN) optical waveguide that couples between the Si optical waveguide and the LN optical waveguide.

6. The optical device according to claim 5, wherein
an output stage side of the Si optical waveguide is formed so as to be tapered in diameter and an output stage side of the SiN optical waveguide is formed so as to be tapered in diameter, and
an output stage of the Si optical waveguide is coupled to an input stage of the SiN optical waveguide, and an output stage of the SiN optical waveguide is coupled to an input stage of the LN optical waveguide.

7. The optical device according to claim 5, wherein
an output stage side of the Si optical waveguide is formed so as to be tapered in diameter, an input stage side and an output stage side of the SiN optical waveguide are formed so as to be tapered in diameter, and an input stage side of the LN optical waveguide is formed so as to be tapered in diameter, and
an output stage of the Si optical waveguide is coupled to an input stage of the SiN optical waveguide, and an output stage of the SiN optical waveguide is coupled to an input stage of the LN optical waveguide.

8. An optical communication apparatus comprising:
a processor that executes signal processing on an electrical signal;
a light source that generates light; and
an optical device that modulates, by using the electrical signal that is output from the processor, the light that is generated from the light source, wherein
the optical device includes
a silicon (Si) substrate,
a ground electrode that is at a ground potential and that is layered on the Si substrate,
a lithium niobate (LN) optical waveguide that is formed by a thin film lithium niobate (LN) substrate that is layered on the ground electrode, and
a signal electrode that is disposed at a position opposite the ground electrode with the LN optical waveguide interposed therebetween and that applies a high-frequency signal.

9. A manufacturing method of an optical device comprising:
forming a recess portion by etching a surface of a first member that has
a silicon (Si) substrate,
a silicon (Si) optical waveguide formed on the Si substrate, and
a buffer layer that covers the Si optical waveguide,
from the buffer layer to a part of the Si substrate; and
mounting a second member that has
a support substrate,
a ground electrode that is at a ground potential and that is layered on the support substrate,
a lithium niobate (LN) optical waveguide that is formed by a thin film lithium niobate (LN) substrate that is layered on the ground electrode, and
a signal electrode that is disposed at a position opposite the ground electrode with the LN optical waveguide interposed therebetween and that applies a high-frequency signal,
in the recess portion such that an optical axis of the Si optical waveguide is aligned with an optical axis of the LN optical waveguide.
